(19) United States
(12) Patent Application Publication
(10) Pub. No.: US 2010/0305996 A1
(43) Pub. Date: Dec. 2, 2010

(54) Method for Creating Timetables for Transportation Systems Taking Into Account Time Limits

(75) Inventor: Karl-Heinz Erhard, Braunschweig (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/680,341

(22) PCT Filed: Sep. 24, 2008
(86) PCT No.: PCT/EP2008/062744

§ 371 Date: Mar. 26, 2010

(30) Foreign Application Priority Data
Sep. 27, 2007 (DE) 10 2007 047 474.3

(51) Int. Cl. G06Q 10/00; G06Q 50/00

(52) U.S. Cl. 705/7

(57) ABSTRACT

A method for the computer-aided automatic creation of timetables for transportation systems takes into account time limits, which are used in the framework of planification tools and online for the planning of timetables as a component of control systems. The invention broadens the method for creating timetables as described in WO 97/09218 (German patent application DE 195 33 127). The object of the invention is to ensure that in particular upper time limits are regarded as operational boundary conditions. A non-linear model of penalty costs is used to achieve this object.

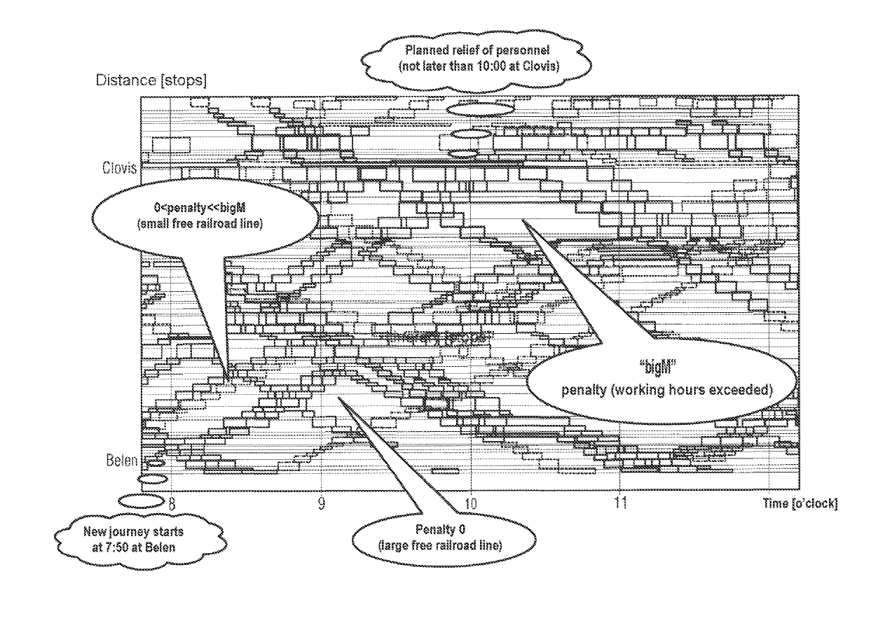

The invention relates to the computer-aided, automatic creation of timetables for transportation systems. The method can be used either offline for timetable design—within the context of planning tools—or online for timetable scheduling—as part of control systems. The invention extends the method described in DE patent application No 19533127 to timetable creation. The claimed method is used to take account of upper time limits, in particular, as operational constraints.

Existing, automatic methods for timetable creation can be divided into two classes:
Incremental methods are based on the current offline or online timetable and make only local changes to said timetable. The decision regarding what timetable adjustment needs to be made is taken, by way of example, using a knowledge base [H. Schaefer et al., An Expert System for Real-Time Train Dispatching, Railway Operations, Computers in Railways 4, Volume 2, COMPRAIL 94, T. Murthy et al (editors), Computational Mechanics Publications, Southampton, ISBN 1-85312-359-5, page 27 to 34, 1994.] or by optimization methods, e.g. Branch-and-Bound-Algorithm according to [R. Sauder, Computer Aided Train Dispatching: Decision Support through Optimization, INTERFACES 13, 5.24 to 37, 1993.].
Structural methods take the operational constraints, e.g. planned passenger stops, vehicle priorities and possibly the actual positions of the vehicle as a basis for calculating a totally new timetable. In [K.-H. Erhard, U. Lauther: Verfahren zur Regelung von Verkehrsmitteln, [Method for regulating means of transport], DE patent application 19533127], this involves the use of fast heuristics based on graphical models and algorithms.

The known methods take account of certain lower time limits, e.g. the fact that the vehicle must not drive away from a passenger stop before the planned departure time. Upper time limits are not taken into account at present. A typical example of the taking into account of upper time limits is the limited working hours of driving personnel, which must not be exceeded where possible. Otherwise, significant operating costs and additional delays arise on account of it being necessary to change personnel at unscheduled relief points.

The invention is based on the object of expanding the known method for creating timetables by the option of taking other time limits into account.

To this end, the invention involves the use of a nonlinear penalty cost model, i.e. penalty model.

The underlying method is structural and produces the new timetable in steps by first of all sorting the journeys to be planned according to priority and then scheduling them individually. An individual journey is planned by representing the railroad lines which are still free—time headways for route sections—using an interval chart, and applying a shortest-distance algorithm to said chart in order to calculate an optimized route. This involves not only topological but also chronological alternatives, particularly instances of overtaking and meeting, being fully taken into account. The target functional value to be minimized which is considered is a weighted delay total for all vehicles. The weighting factor is greater the higher the priority of the vehicle.

A drawback of the known basic method is the property that it is no longer possible to alter journeys which have already been scheduled. A railroad line which is still free can thus only be used for a replacement journey if its time range is sufficiently large to accommodate the traveling time and possibly planned waiting time. This can result in the breaching of upper time limits for trains which are scheduled later.

To overcome this drawback, the method according to the invention involves taking a first model expansion as a basis for permitting the use of a free railroad line generally and penalizing it with a suitable value. The penalty value is added to the target functional value for the solution under consideration. This means that any already scheduled vehicle can, in principle, be displaced by subsequently scheduled vehicles. For calculating the penalty, a distinction is drawn between the following cases:
1. The planned journey by the railroad line is possible without displacement: in this case, the penalty value is 0.
2. To make the journey on the selected railroad line, other vehicles must be displaced, i.e. delayed: in this case, the additional delay to the other vehicles is ascertained and is added to the target functional value. To allow for the different vehicle priorities, the delay supplement is multiplied by the respective weighting factor for the displaced journeys.

A second model expansion now involves an additional, particularly large penalty value—bigM method—being provided for the railroad lines beyond the upper time limits. This value is greater than the maximum value of the possible solutions without taking account of the bigM value. Without the use of this value, it could occur that a solution breaching the limit is produced even though an admissible solution would exist.

On the basis of these model expansions, the following practical method steps for planning a new journey are proposed:
a) Calculate the shortest route on the interval chart taking account of the individual penalty values for the individual railroad lines which are still free
b) Check the target functional value of the solution obtained.
   b1) If the value is less than bigM, no upper time limit is breached. In this case, the solution obtained is admissible. If some vehicles need to be displaced in the selected solution, their journeys are updated accordingly. If, after this update, an upper time limit is breached for a displaced vehicle, the procedure is as in step b2).
      b2) If the value is greater than or equal to bigM, the solution is inadmissible on account of time limits being breached. In this case, a suitable alternative solution is determined. In a specific case of the working hours of the driving personnel being exceeded, the relief point is relocated toward the current position of the vehicle.

The proposed penalty cost model can be used in a similar manner to take account of lower time limits. If, for example, a vehicle is not meant to arrive at a particular position for a particular time, the bigM value would be applied to the railroad lines which are ahead of this time.

The invention will be explained in more detail using an exemplary embodiment with reference to the distance/time chart shown in the drawing.

In the distance/time chart shown, the time between 8 and 12 o'clock is plotted on the x axis and the distance with an indication of the stations is plotted on the y axis.

A journey comprises a sequence of time intervals. Each time interval describes the use of a particular route section—e.g. traffic channel—by a particular vehicle. The white fields between these intervals are the railroad lines which are still free and which can be used for planning the next journey.

It is now assumed that at the bottom left—at the Belen stop—a new journey to be scheduled starts at 7:50 am and that at no later than 10 o'clock at the top center—at the Clovis station—the personnel are intended to be relieved. To take account of this upper time limit, the following penalty cost model is set up:
Free railroad lines which are situated in the left-hand part, namely before 10 o'clock, have a positive penalty less than bigM applied to them if their time range is so short that the use of the railroad line for the journey which is to be planned would entail displacing, i.e. delaying, already planned journeys. If no displacement is necessary, there is no penalization.
The free railroad lines in the right-hand part, namely after 10 o'clock, have the particularly large penalty bigM applied.

This modeling results in the shortest-distance algorithm determining, where possible, a route through the free railroad lines which involves the vehicle arriving at Clovis at no later than 10 o'clock. If the vehicle is already so severely delayed that even displacing all existing journeys results in the maximum admissible working hours being exceeded, the solution obtained would use a railroad line to the right of 10 o'clock and would therefore result in a target functional value greater than bigM. In this case, the method would propose shifting the relief point toward the starting station.

By introducing the penalty cost model according to the invention for taking account of time limits for creating timetables, the following advantages are obtained:
The quality of the solution obtained in terms of target functional value is improved further in comparison with the known method because the potential displacement of already scheduled journeys significantly increases the size of the solution space under consideration.
An admissible solution is ascertained very efficiently within just one calculation operation, i.e. backtracking is not required.
The use of upper time limits serves to avoid exceeding working hours, for example. This results in significant cost savings for the customer.
Lower time limits can be used, by way of example, to prevent positions with limited vehicle capacity, e.g. depots, from being overfilled.
The combination of lower and upper time limits can be used for just-in-time planning, e.g. for optimized warehousing of the transported goods.

Since an existing, structural method for creating timetables is expanded, the advantages thereof are adopted:
The structural approach allows the timetables to be optimized as globally as possible.
The method can be used for general transportation networks, not just for transportation companies.
The calculation of admissible and optimized timetables is particularly efficient as a result of the use of fast heuristics, which allows the method to be used not only for offline applications but also for online applications.

1-4. (canceled)

5. A method for creating timetables for transportation systems taking into account time limits, the method which comprises the following steps:
sorting journeys to be planned according to priority and then scheduling the journeys individually;
planning an individual journey by representing tracks that are still free, time gaps for route sections, with an interval chart, and calculating an optimized route by applying a shortest-distance algorithm to the interval chart, and thereby fully taking into account topological and chronological alternatives;
defining a weighted delay total for all vehicles as a target functional value to be minimized, wherein a weighting factor is greater the higher a priority of a given vehicle;
permitting use of a free track in general and penalizing the use with a suitable penalty value, enabling, in principle, each already scheduled vehicle to be displaced by subsequently scheduled vehicles; and
adding the penalty value to the target functional value for the solution under consideration.

6. The method according to claim 5, wherein the topological and chronological alternatives include instances of overtaking and meeting.

7. The method according to claim 5, which comprises, if the planned journey through the track is possible without displacement, setting the penalty value equal to 0.

8. The method according to claim 5, which comprises, if making the journey on the chosen track requires other vehicles to be displaced or delayed, ascertaining the additional delay to the other vehicles and adding to the target functional value, and, depending on a vehicle priority, multiplying the additional delay by the respective weighting factor for the displaced journeys.

9. The method according to claim 5, which comprises, on a basis of a model expansion, providing an additional, particularly large penalty value (“bigM value”) for the tracks beyond the upper time limits, the large penalty value being greater than a maximum value of the possible solutions without taking account of the large penalty value.
